(19) United States
(12) Patent Application Publication
(10) Pub. No.: US 2017/0036216 A1
(43) Pub. Date: Feb. 9, 2017

(54) Gold pan with porous agitator/classifier

(71) Applicant: Christian Putnam Cosby, Lewiston, ID (US)

(72) Inventor: Christian Putnam Cosby, Lewiston, ID (US)

(21) Appl. No.: 15/222,949

(22) Filed: Jul. 29, 2016

Related U.S. Application Data
(60) Provisional application No. 62/202,827, filed on Aug. 8, 2015.

(51) Int. Cl. B03B 7/00; B07B 1/02; B03B 5/26

(52) U.S. Cl. CPC B03B 7/00; B03B 5/26; B07B 1/02

(57) ABSTRACT

An elongated gold pan with handles and a porous agitator/classifier

### CROSS-REFERENCE TO RELATED APPLICATIONS

This application claims priority to provisional application 62/202,827 filed on Aug. 8, 2015.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC

Not Applicable

### STATEMENT REGARDING PRIOR DISCLOSURES BY AN INVENTOR OR JOINT INVENTOR

Not Applicable

### BACKGROUND OF THE INVENTION

This invention relates generally to an apparatus for separating and concentrating precious metals from less dense materials using a hand-held device and the combination of hydraulic and gravitational actions.

Conventional gold pans are generally circular with concentric circular ridges. Material potentially containing precious metals is placed in the pan and water is added. The pan is grasped by the lip with both hands. The pan is then tipped slightly and rotated in a generally circular motion. The momentum of the moving water carries material having a lower specific gravity toward the lip and out of the pan. The ridges catch material having a higher specific gravity and prevent the material from being carried out of the pan.

Conventional sluice boxes separate and concentrate precious metals from less dense materials by using hydraulic action and a generally unidirectional flow. The box is generally a trough with an open end and some structures designed to induce turbulent hydraulic action and capture material having a relatively high density. Material which potentially contains precious metals is added to the higher end. Relatively large amounts of water are then added at the higher end. Structures in the trough induce turbulent water flow. The turbulent water flow carries materials having a lower specific gravity toward the ends of the trough and eventually out of the trough. Materials having a higher specific gravity are captured in the structures in the trough.

Using a gold pan generally involves getting one's hands wet and permits the operator to process a relatively small amount of material. However, gold pans are generally light weight and portable. Sluice boxes can generally process a greater amount of material than a gold pan, but sluice boxes are generally less portable than gold pans.

### BRIEF SUMMARY OF THE INVENTION

The invention is an elongated trough open at both ends and on top. The bottom of the trough contains a plurality of depressions. The depressions may contain raised features. The top of the trough contains a plurality of handles. By way of example and not limitation, the handles may be fixed, may rotate, may be removable, and may be combinations of the preceeding. The trough is configured to facilitate insertion of a removable porous agitator/classifier over the bottom of the trough. The invention includes a removable porous agitator/classifier which may be inserted over, and attached to, the bottom of the trough.

### BRIEF DESCRIPTION OF THE SEVERAL VIEWS OF THE DRAWING

FIG. 1 shows the trough shape of the device. It also shows rectangular depressions in the bottom of the trough and rotatably attached handles connected to both sides.

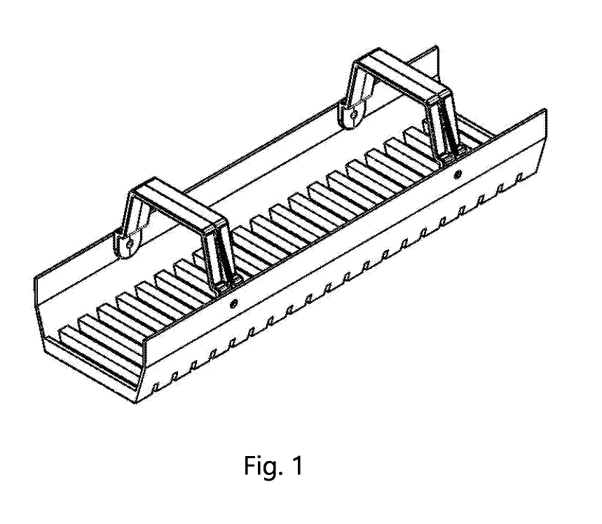

FIG. 2 shows a sieve (porous agitator/classifier) configured to fit adjacently over the bottom of the trough.

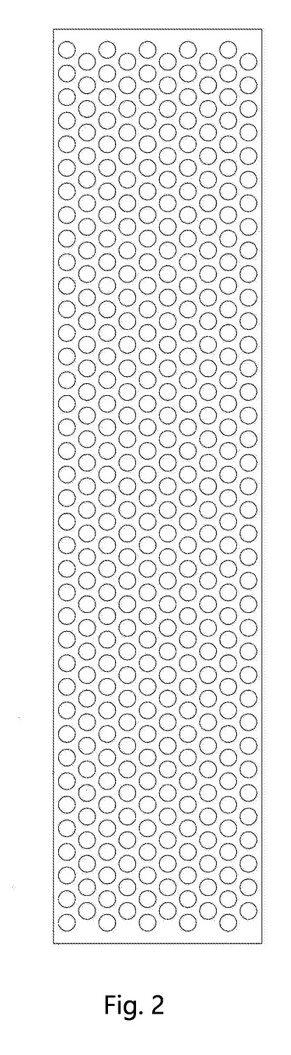

### DETAILED DESCRIPTION OF THE INVENTION

As used herein, a trough is defined as a container having a greater length than width.

The invention is an elongated trough open at both ends and on top. The bottom of the trough contains a plurality of depressions. In a preferred embodiment, the depressions are rectangular running generally the width of the trough. In an alternative embodiment, the depressions are generally square with multiple depressions covering the width of the trough having a depth approximately the length of the depressions. In an alternative embodiment, a cross-section of the tops of the depressions form a “T” shape, not necessarily at right angles. In an alternative embodiment, the walls of the depressions are partially or entirely angled.

The top of the trough contains a plurality of handles. By way of example and not limitation, the handles may be fixed, may rotate, may be removable, and may be combinations of the preceding. The shape, structure, and construction of the trough allow it to support the weight of itself, without significantly deforming, when filled with rock and water when suspended from the handles.

The trough is configured to facilitate insertion of a removable sieve (porous agitator/classifier) over the bottom of the trough. In a preferred embodiment, the porous agitator/classifier is expanded or perforated metal. In the case of a perforated porous agitator/classifier, the diameter of the perforations is slightly less than than the width of the depressions in the bottom or the trough. In a preferred embodiment, porous agitator/classifier is slightly bowed, concave up, creating relatively consistent pressure along the length of the trough when the porous agitator/classifier is secured to the trough at the ends of the trough. In a preferred embodiment the porous agitator/classifier is secured to the trough using binder clips. In an alternative embodiment, the porous agitator/classifier is secured to the trough using screws and wing nuts passing through the porous agitator/classifier and trough. In an alternative embodiment, the porous agitator/classifier snaps into the trough by pressing the porous agitator/classifier downward past or onto retention features configured into the trough. In an alternative embodiment, the porous agitator/classifier slides into a groove in the trough immediately above the depressions.

The device is used by placing a quantity of material in the approximate length-wise middle of the trough. The handles are held in the operators hands. The device is partially submerged in water with the bottom of the trough beneath the surface of the water and the handles above the surface of the water. The operator rocks the trough side-to-side. Hydraulic action carries material having a lower density further faster and eventually out of the trough. The porous agitator/classifier prevents large material from becoming caught in trough's depressions allowing it to more easily pass through and out of the device. The porous agitator/classifier also increases the hydraulic action of passing across the porous features. Once a sufficient amount of low density material has passed out of the trough, the operator is left with concentrate in the depressions. The concentrate can be further processed or accumulated

1. A device for separating higher density material from lower density material comprising:
a. a trough having side walls, open ends, and an open top;
b. a plurality of grooves formed into the bottom of the trough; and
c. one or more handles attached to the trough.

2. The device of claim 1 wherein the grooves slope up from the center of the trough to the sides walls of the trough.

3. The device of claim 2 further comprising a plurality of raised features formed into the bottom of the grooves.

4. The device of claim 3 further comprising:
a. a sieve configured to cover the bottom of the trough; and
b. said sieve configured to be detachably mounted adjacently over the bottom of the trough.

5. The device of claim 4 wherein the sieve is configured to prevent the passage of the material having a diameter greater than the width of the grooves.

6. The device of claim 4 wherein the one or more handles are attached to both sides of the trough.

7. The device of claim 6 wherein the handles are rotatably attached to the trough.

8. The device of claim 4 wherein the handles are fixedly attached to the trough.

9. The device of claim 2 further comprising:
a. a sieve configured to cover the bottom of the trough; and
b. said sieve configured to be detachably mounted adjacently over the bottom of the trough.

10. The device of claim 9 wherein the sieve is configured to prevent the passage of the material having a diameter greater than the width of the grooves.

11. The device of claim 9 wherein the one or more handles are attached to both sides of the trough.

12. The device of claim 11 wherein the handles are rotatably attached to the trough.

13. The device of claim 9 wherein the handles are fixedly attached to the trough.
